(19) United States
(12) Patent Application Publication
(10) Pub. No.: US 2009/0265912 A1
(43) Pub. Date: Oct. 29, 2009

(54) EVAPORATOR FAN REMOVAL AND INSTALLATION DEVICE

(75) Inventor: Scott D. Fulmer, Liverpool, NY (US)

Correspondence Address: MARJAMA MULDOON BLASIAK & SULLIVAN LLP, 250 SOUTH CLINTON STREET, SUITE 300, SYRACUSE, NY, 13202, US

(73) Assignee: CARRIER CORPORATION, Farmington, CT (US)

(21) Appl. No.: 12/427,378

(22) Filed: Apr. 21, 2009

Related U.S. Application Data
(60) Provisional application No. 61/047,259, filed on Apr. 23, 2008.

(51) Int. Cl. B23P 19/04; B23Q 3/00; B23Q 7/04

(52) U.S. Cl. 29/525.02; 29/283

(57) ABSTRACT

A tool is provided for maintaining the position of a fan during periods in which the retaining nut is applied or removed from the electric motor drive shaft. The tool includes a central portion with an opening to fit over the nut and to act as a fulcrum for the tool. Extending radially outward from each side of the central portion is a torque member that fits against the respective blades to hold them in place during rotation of the nut.

### CROSS-REFERENCE TO RELATED APPLICATION

Reference is made to and this application claims priority from and the benefit of U.S. Provisional Application Ser. No. 61/047,259, filed Apr. 23, 2008, and entitled EVAPORATOR FAN REMOVAL AND INSTALLATION DEVICE, which application is incorporated herein in its entirety by reference.

### TECHNICAL FIELD

This invention relates generally to transport refrigeration systems, and more particularly, to a tool for installing or removing a fan blade from an evaporator.

### BACKGROUND OF THE INVENTION

In transport refrigeration systems, such as are used with refrigerated truck trailers and refrigerated containers, evaporator fans are applied to circulate return air from the space being refrigerated through the evaporator coil prior to its being recirculated back to the space for cooling of the cargo. Such evaporator fans are normally driven by an electric motor, with the fan being attached to the motor drive shaft by way of a nut that is threadably engaged with the drive shaft.

In the maintenance and repair of such systems, it is commonly necessary to remove a fan for purposes of repair or replacement. In order to remove the threaded nut from the shaft, it is necessary to prevent rotation of the shaft, and this is normally accomplished by holding the fan in place. Traditionally this has been accomplished by a service person holding the fan with one hand and turning the nut by way of wrench with the other hand. However, this can be awkward and difficult to execute the two functions simultaneously. Further, it can result in injury if not properly executed.

### DISCLOSURE OF THE INVENTION

In accordance with one embodiment of the invention, a tool is provided with an opening to be placed over the drive shaft, and with a pair of oppositely disposed torque members extending radially outwardly and engageable with fan blades to hold the fan in place while the nut is either installed or removed from the drive shaft.

### BRIEF DESCRIPTION OF THE DRAWINGS

FIG. 1 is a perspective view of a mock up form of the tool in accordance with the present invention.

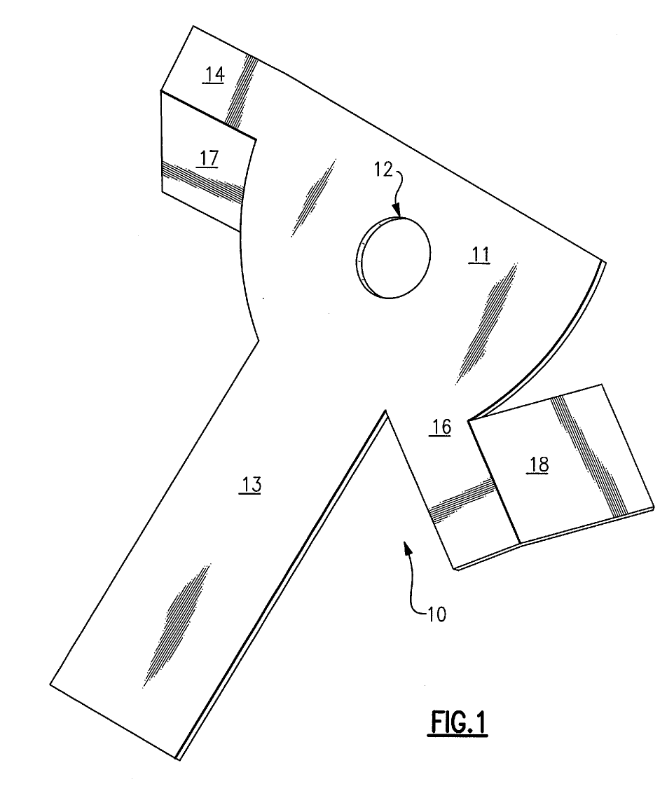

FIG. 2 is a perspective view of the tool as being applied to an evaporator fan for removal of the retaining nut.

### DETAILED DESCRIPTION OF THE INVENTION

The inventive tool is shown generally at 10. The tool 10 comprises a central portion 11, which is generally planar in form and has an opening 12 formed therein. Integrally attached and extending outwardly in the same plane of the central portion is a lever arm 13.

Attached to and extending radially outwardly from the central portion 11 is a pair of torque members 14 and 16, and attached to the torque members 14 and 16, respectively, and extending downwardly from the plane of the central portion 11, are engagement portions 17 and 18. The engagement portions 17 and 18 are swept in a counterclockwise direction to facilitate engagement with the blade as will be described.

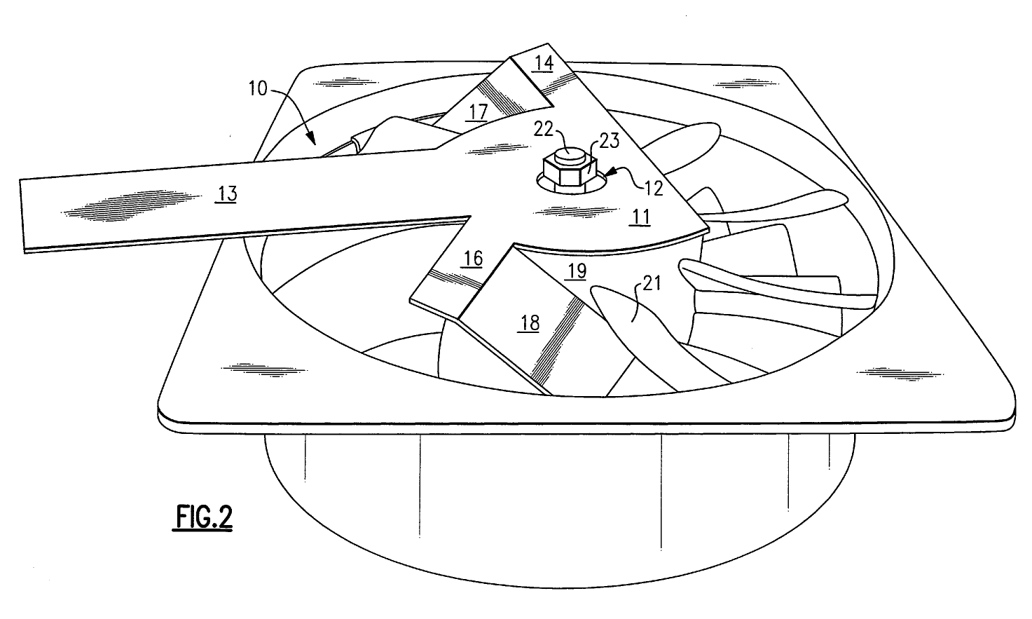

Referring now to FIG. 2, the inventive tool 10 is shown in an installed position over a fan hub 19 and blades 21, with the fan hub 19 being placed with its central opening over the drive shaft 22 of an electric motor (not shown). A nut 24 is threadably engaged with the drive shaft for securing the fan to the electric motor.

As will be seen, the opening 12 provides for a centering of the tool over the fan in such a way that the engagement portions 17 and 18 engage the underside of their respective blades such that, when the nut 23 is turned clockwise to tighten the nut 23 on the shaft 22, the engagement of the engagement portions 17 and 18 with the respective fan blades prevent the fan from turning in the same direction. The lever arm 13 provides a mechanical advantage to assist the operator in this effort, and the central opening 12 provides a center of rotation and a fulcrum for the tool for that purpose.

The tool can be composed of any suitable material, such as steel or the like, that will provide the necessary rigidity to perform the function as described.

While the present invention has been particularly shown and described with reference to the preferred mode as illustrated in the drawing, it will be understood by one skilled in the art that various changes in detail may be effected therein without departing from the spirit and scope of the invention as defined by the claims.

We claim:

1. A tool for installing or removing a fan attached to an electric motor drive shaft, comprising:
a central portion being substantially planar in form and having a central opening formed therein for placement over said drive shaft; and
a pair of torque members attached to said central portion and extending radially outwardly therefrom with each of said torque members having an engagement portion which extends downwardly from the plane of said central portion so as to be engageable with a fan blade to prevent rotation of the fan when a nut is tightened on the drive motor shaft.

2. A tool as set forth in claim 1 and including a lever member rigidly attached to and extending radially outwardly from said central portion to facilitate the exertion of force against the blade in one rotational direction while turning of the nut in the opposite direction.

3. A tool as set forth in claim 1 wherein said pair of torque members are generally on opposite sides of said central portion.

4. A tool as set forth in claim 1 wherein said engagement portions are generally swept in a counterclockwise direction so as to engage an underside of their respective fan blades.

5. A method of installing or removing an evaporator fan from a shaft of an electric drive motor, comprising the steps of:
providing a tool having a central planar portion with an opening formed therein and with a pair of oppositely disposed torque arms attached thereto;
placing the tool over the fan propeller with the shaft passing through the tool opening and with the torque arms engaging respective fan blades; and
while holding the tool to prevent rotation of the fan propeller, tightening or loosening the nut on said shaft.

6. A method as set forth in claim 5 and including the step of providing a lever member rigidly attached to and extending radially outwardly from said central portion to facilitate the exertion of force against the blade in one rotational direction while turning of the nut in the opposite direction.

7. A method as set forth in claim 5 wherein said pair of torque members are generally on opposite sides of said central portion.

8. A method as set forth in claim 5 wherein said pair of torque arms are generally swept in a counterclockwise direction so as to engage an underside of their respective fan blades.
